(19) United States
(12) Patent Application Publication
(10) Pub. No.: US 2005/0221047 A1
(43) Pub. Date: Oct. 6, 2005

(54) Panel element comprising a connection system

(76) Inventor: Wilfried Weitzer, Krottendorf (AT)

Correspondence Address: Steven J Hultquist;Intellectual Property Technology Law, PO Box 14329, Research Triangle Park, NC, 27709, US

(21) Appl. No.: 10/518,441

(22) PCT Filed: Jun. 18, 2003
(86) PCT No.: PCT/EP03/06473

§ 371 Date: Apr. 7, 2005

(30) Foreign Application Priority Data
Jun. 19, 2002 (AT) A 922/2002

(51) Int. Cl. B32B 3/00

(52) U.S. Cl. 428/60

(57) ABSTRACT

A panel element having a utilization side, a counter draw opposite the utilization side, a first longitudinal side having a tongue, a second longitudinal side which is located opposite the first longitudinal side and has a groove with a contour opposite to that of the tongue, the tongue having a first projection (21) extending beyond the utilization side in a first direction parallel to the utilization side and normal to the longitudinal direction of the tongue and a second projection (22) extending in the first direction, a first undercut (23) being formed between the first projection (21) and the second projection (22), wherein at least one first region (25) of the second projection (22) has a distance from the tongue-side edge (18) of the utilization side (11) which is smaller than a second region (26) of the first undercut (23).

The present invention relates to a panel element having a utilization side, a counter draw opposite the utilization side, a first longitudinal side having a tongue, a second longitudinal side which is located opposite the first longitudinal side and has a groove with a contour opposite to that of the tongue, the tongue having a first projection extending beyond the utilization side in a first direction parallel to the utilization side and normal to the longitudinal direction of the tongue.

Such known panel elements are used in particular for floor elements, it being possible by special tongue developments to prevent translations normal to the longitudinal axis of the tongue when the panel elements are connected. A drawback of these known panel elements is that when the panel element is loaded high stress peaks are often generated in the tongue, which may result in a failure of the panel element.

It is therefore the object of the present invention to provide a panel element of the above mentioned kind which avoids these known drawbacks, in which loads of the panel element can be received by the tongue as uniformly as possible and which can be laid easily and rapidly without an adhesive or the like.

According to the invention this is achieved because in the region of the counter draw (of the side facing away from the utilization side) the tongue has a second projection extending in the first direction, a first undercut being formed between the first projection and the second projection, and because at least a first region of the second projection has a distance from the tongue-side edge of the utilization side (of the top side on which one can walk when laid) which is smaller than that of a second region of the first undercut.

In addition, in the first direction, the first region of the second projection can be farther away from the panel element than the second region and the “first direction” can be parallel to the utilization side and normal to the longitudinal direction of the tongue.

This is an advantage because in addition to the first projection the second projection can also transmit forces normal to the utilization side, so that the stress peaks of tongue and groove can be kept small when the panel element according to the invention is loaded.

A further development of the invention may provide that the first undercut has a constriction in its opening region. The support between groove and tongue can be improved by the constriction.

A further embodiment of the invention may provide that the tongue has at least one extension and/or a second undercut in a second direction which is normal to the utilization side. The extension and/or the second undercut ensure the support of tongue and groove in the first direction.

A further embodiment of the invention may provide that the first projection comprises the extension and/or the second undercut. As a result, the necessary thickness of the panel element can be kept small.

A further embodiment of the invention may provide that the first undercut and the second undercut are merged. This embodiment enables simple tongue geometry.

A further development of the invention may provide that the tongue has at least five contact points for power transmission. Stress peaks in the groove and/or tongue can be kept particularly small under a load because of the large number of contact points.

A further embodiment of the invention may provide that the second projection of the tongue can be locked with the groove by an audible and noticeable click. This serves for easily determining that the tongue and groove joint has been established properly when the panel element according to the invention is laid.

A further embodiment of the invention may provide that the longitudinal sides and/or face sides are at least partially treated, in particular sprayed, coated or the like, with a hydrophobic agent. This serves for increasing the durability of the panel element according to the invention, the panel element according to the invention remaining dimensionally stable even in the case of penetrating moisture.

A further development of the invention may provide that glue channels form when tongue and groove are joined. If necessary, the tongue and groove joint can be made particularly durable by introducing an adhesive into at least one of the glue channels.

Examples of panel elements within the meaning of the invention are parquet elements according to DIN 280 or laminate elements according to EN 13329.

The invention is described in more detail with reference to the attached drawings which show embodiments thereof.

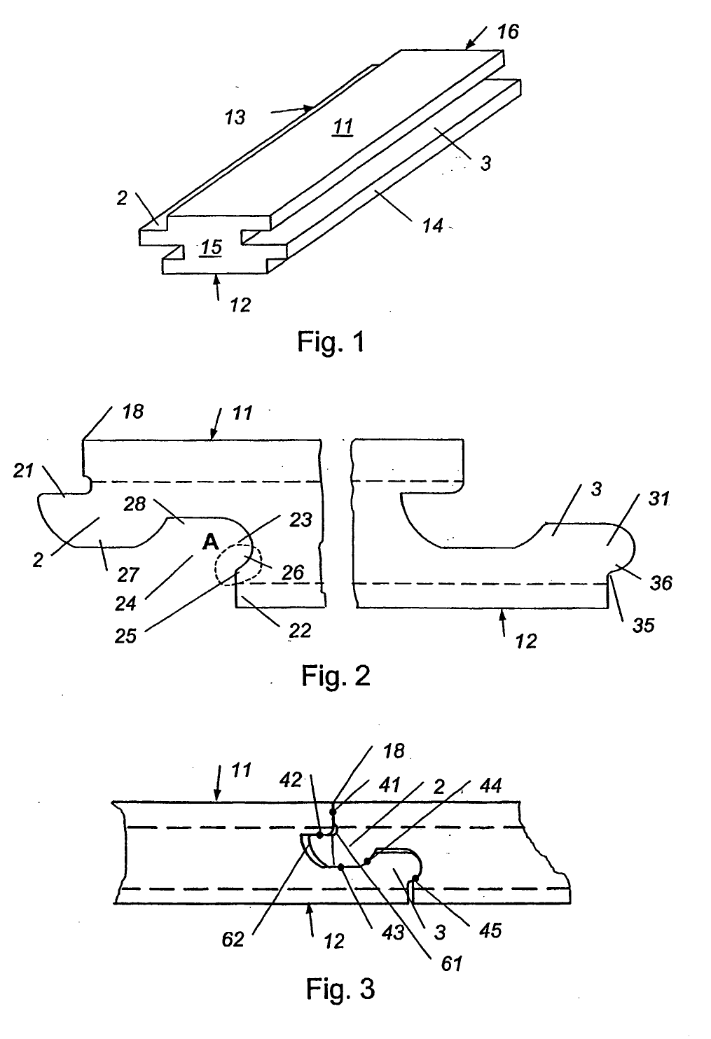

FIG. 1 shows a schematic oblique view of a panel element according to the invention;

FIG. 2 shows a cross-section of a first embodiment of the panel element according to the invention;

FIG. 3 shows the tongue and groove joint of the panel element according to FIG. 2 of the invention;

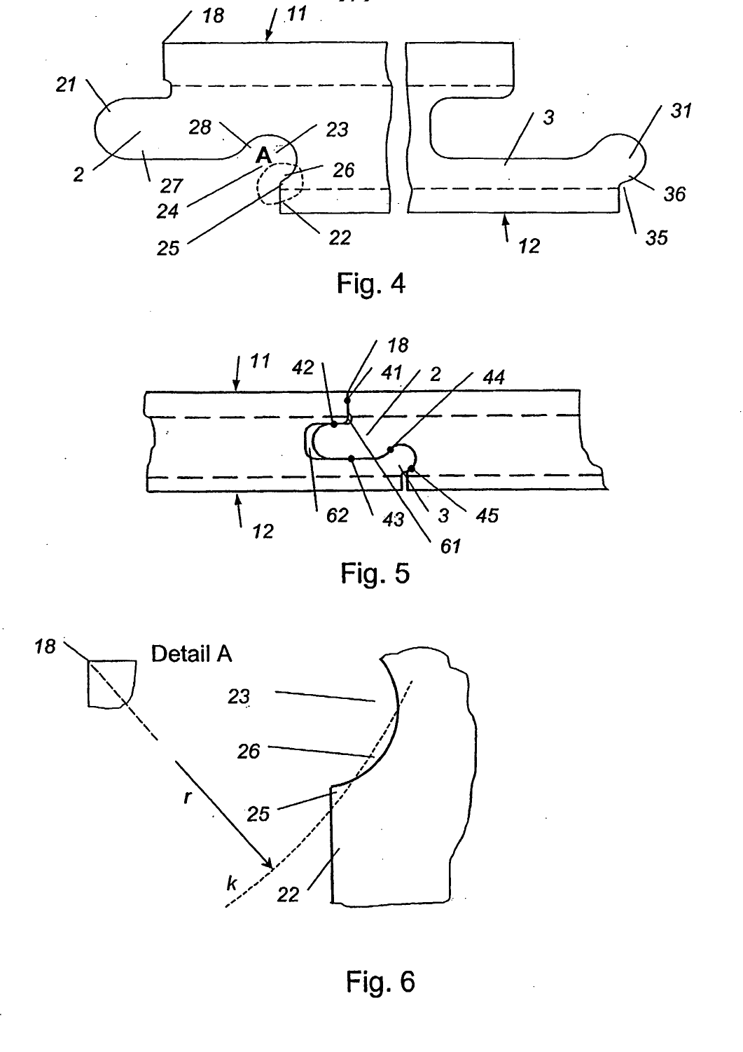

FIG. 4 shows a cross-section of another embodiment 1 of the panel element 18 according to the invention;

FIG. 5 shows the tongue and groove joint of the panel element according to FIG. 4 of the invention; and

FIG. 6 shows an enlarged diagram of detail A of the cross-sectional view according to FIG. 2 or 4.

FIG. 1 shows a schematic oblique view of a panel element according to the invention. The panel element according to the invention has a utilization side 11, a counter draw 12 opposite the utilization side, a first longitudinal side 13 having a tongue 2, a second longitudinal side 14 which is located opposite the first longitudinal side 13 and has a groove 3 with a contour opposite to that of tongue 2 and two face sides 15, 16.

The panel element according to FIG. 1 of the invention has a substantially rectangular shape 1. It may also be square or have another shape, such as rhombic, triangular, hexagonal, octagonal, oval or the like.

FIG. 2 shows the cross-section of a first embodiment of the panel element according to the invention, the cross-section being normal to the longitudinal direction of tongue 2. Tongue 2 has a first projection 22 extending beyond the utilization side 11 in a first direction parallel to the utilization side and normal to the longitudinal direction of tongue 2, a first undercut 23 being formed between the first projection 21 and the second projection 22.

At least a first region 25 of the second projection 22 has a distance from the tongue-side edge 18 of the utilization side 11 which is smaller than that of a second region 26 of the first undercut 23, in the extension direction of the projection 22, the first region 25 being farther away from the panel element than the second region 26. FIG. 6 shows detail A of the cross-sectional view according to FIG. 2 or FIG. 4, namely an enlarged portion of the second projection 22 and the first undercut 23. k designates a segment of a circle whose center is the tongue-side edge 18 of the utilization side 11 and which has the radius r. It follows from FIG. 6 that the distance of the first region 25 of the second projection 22 from the tongue-side edge 18 of the utilization side 11 is smaller than r and the distance of the second region 26 of the first undercut 23 is larger than r. Therefore, the first region 25 of the second projection 22 has a distance from the tongue-side edge 18 of the utilization side 11 smaller than that of the second region 26 of the first undercut 23.

Groove 3 has a contour opposite to that of tongue 2 and has a third projection 31 extending beyond the counter draw 12 in the first direction, in the connected state of the tongue and groove joint, a fourth region 36 of the third projection 31 coinciding with the second region 26 of the first undercut and a third region 35 which borders on the third projection 31 and is not materialized at groove 3 substantially coinciding with the first region 25 of the second projection 22.

When the tongue and groove joint of the panel element according to the invention is established, one of the panel elements according to the invention is attached in an inclined fashion to groove 3 of another panel element according to the invention and the tongue and groove joint is substantially established by a rotary motion, tongue 2 being locked in groove 3. Here, the first region 25 of the second projection 22 is moved over the fourth region 36 of the third projection 31 of groove 3. This results in a semi-plastic deformation of groove 3 and/or tongue 2, a lock resistance having to be overcome. In the final position of the tongue and groove joint, the semi-plastic deformation can at least partially be reconverted, tongue 2 snapping into groove 3 with an audible clicking noise. The change in the toggle resistance during snapping is also noticeable. The audible and noticeable click provides a simple and safe control as to whether the tongue and groove joint has been fully established, the tongue and groove joint of the panel element according to the invention being detachable without clearance, without gaps and without being destroyed.

In addition, a contact point 45 is formed between the first region 25 of the second projection 22 and the fourth region 36 of the third projection 31. The advantage of this contact point 45 is that it can transmit forces towards the utilization side 11. As a result, in the joined state of the tongue and groove joint, at least one contact point 41, 42, 43, 44, 45 can be formed on both the first projection 21 and the second projection 22 of tongue 2. This contact point can transmit forces towards the utilization side 11, which force tongue 2 upwards with respect to groove 3. Contact point 45 of the second projection 22 serves for achieving that the tongue and groove joint can transmit loads of one of the panel elements according to the invention without high stress peaks being developed in the region of tongue 2 and/or groove 3.

The tongue and groove joint of the first embodiment of the panel element according to the invention is shown in FIG. 3. In order to disconnect the tongue and groove joint, the panel element shown on the right is pivoted upwards, wherein during the pivoting-up from the position shown in FIG. 3 the present axis of rotation is substantially the tongue-side edge 18 of utilization side 11, i.e. the panel element shown on the right of FIG. 3 is rotated about the tongue-side edge 18 of utilization side 11. In this movement from the position shown in FIG. 3, the first region 25 of the second projection 22 is guided over the fourth region 36 of the third projection 31. The force required for the semi-plastic deformation of tongue 2 and/or groove 3 in the region of the contact point 45 protects the tongue and groove joint from an unintended disconnection of the joint.

According to FIG. 2, tongue 2 has at least one extension 27 and a second undercut 28 in the second direction. In yet another embodiment of the panel element according to the invention, only extension 27 or only the second undercut 28 may be formed. It is also possible to provide several extensions 27 and/or second undercuts 28. Here, it has proved advantageous for the first projection 21 to comprise the extension 27 and/or the second undercut 28. As a result, the necessary height of the tongue and thus the panel elements according to the invention can be kept low.

Particularly simple geometries of tongue 2 and groove 3 can be achieved if the first undercut 23 and the second undercut 28 are merged, i.e. substantially a single undercut is formed which extends in both the first direction and the second direction. In this case, the first undercut 23 has to be regarded as a component in the first direction and the second undercut 28 has to be regarded as a component in the second direction.

FIG. 3 shows as points the further contact points 41, 42, 43, 44 in addition to contact point 45. The tongue and groove joint of the first embodiment of the panel element according to the invention has five contact points 41, 42, 43, 44, 45. On account of the plurality and arrangement of contact points 41, 42, 43, 44, 45 loads of one of the panel elements according to the invention can be transmitted via the tongue and groove joint to adjacent panel elements according to the invention, no excess stress peaks occurring in either tongue 2 or groove 3. In this connection, it has proved favorable that at contact point 45 a force component can also be transmitted in the second direction between the panel elements according to the invention.

FIGS. 4 and 5 relate to other embodiments of the panel element according to FIGS. 2 and 3 of the invention. The first undercut 23 has a constriction in its opening 24 region, the first region 25 of the second projection 22 bordering on the constriction. This is particularly evident from detail A which is enlarged in FIG. 6.

A long durability of the panel element according to the invention and its connection according to the invention can be obtained when the longitudinal sides 13, 14 and/or the face sides 15, 16 are at least partially treated, in particular sprayed, coated or the like, with a hydrophobic agent.

When tongue 2 and groove 3 are connected, glue channels 61, 62 form. An adhesive can be introduced into these regions prior to the connection so that tongue 2 is stuck together with groove 3 and a particularly durable and loadable tongue and groove joint is achieved.

1. A panel element having a utilization side, a counter draw opposite the utilization side, a first longitudinal side having a tongue, a second longitudinal side which is located opposite the first longitudinal side and has a groove with a contour opposite to that of the tongue, wherein the tongue having a first projection extending beyond the utilization side in a first direction parallel to the utilization side and normal to the longitudinal direction of the tongue, in the region of the counter draw, the tongue having a second projection extending in the first direction, a first undercut being formed between the first projection and the second projection, the groove having a third projection extending beyond the counter draw in the first direction; and for creating a tongue and groove joint the tongue being attached in an inclined fashion to the groove of another similar panel element and substantially on account of a rotary motion the tongue and groove joint being established by locking the tongue in the groove of the other similar panel element, wherein the second projection of the tongue can be locked with the third projection of the groove of the other similar panel element and a semi-plastic deformation of the second projection of the tongue and/or the third projection of the groove of the other similar panel occurs during locking.

2. The panel element according to claim 1, wherein the first undercut has a constriction in its opening region.

3. The panel element according to claim 1, wherein the tongue has at least one extension and/or one second undercut in the second direction normal to the utilization side.

4. The panel element according to claim 3, wherein the first projection comprises the extension and/or the second undercut.

5. The panel element according to claim 3, wherein the first undercut and the second undercut are merged.

6. The panel element according to claim 1, wherein when the tongue is connected with the groove of another similar panel element, the tongue and groove have at least five contact points for power transmission.

7. The panel element according to claim 1, wherein the second projection of the tongue can be locked with the third projection of the groove of the other similar panel element by an audible and noticeable click.

8. The panel element according to claim 7, wherein when the tongue is connected with the groove of another similar panel element the semi-plastic deformation is at least partially reconverted.

9. The panel element according to claim 1, wherein the longitudinal sides and/or the face sides are at least partially treated, in particular sprayed, coated or the like, with a hydrophobic agent.

10. The panel element according to claim 1, wherein glue channels form when the tongue is connected with the groove of another similar panel element.

11. A interlocking floor system comprising at least two panel elements, wherein a panel element comprises:
a utilization side;
a counter draw side postioned opposite the utilization side;
a first longitudinal side;
a second longitudinal side positioned opposite the first longitudinal side, wherein the first and second longitudinal sides are generally normal to the utilization and counter draw side, wherein the first longitudinal side comprises:
a first projection adjacent and parallel to the utilization side and extending beyond both the utilization side and the counter draw side; and
a second projection adjacent and parallel to the counter draw side, wherein the first projection and second projection extend in a first direction and the first projection extends further beyond the second projection in an amount sufficient to form a first undercut therebetween;
wherein the second longitudinal side comprises:
a second undercut adjacent and parallel to the utilization side and having a contour corresponding to the contour of the first projection; and
a third projection that extend in a direction opposite to the first direction and is positioned adjacent and parallel to the draw side, wherein the third projection extends beyond both the utilization side and the counter draw side in a sufficient amount to form a contour corresponding to the contour of the first undercut; and
wherein a rotary motion locks the first projection of a first panel element into the second undercut of a second panel element and locks the third projection of the second panel element into the first undercut of the first panel element.
